(19) United States
(12) Patent Application Publication
(10) Pub. No.: US 2010/0201023 A1
(43) Pub. Date: Aug. 12, 2010

(54) METHOD FOR PREPARING COMPOSITE MATERIALS

(75) Inventors: Patrick Piccione, Pau (FR); Catherine Bluteau, Orthez (FR); Benoit Brule, Beaumont Le Roger (FR); Alexander Korzhenko, Saint Victor D'Epine (FR)

Correspondence Address: MILLEN, WHITE, ZELANO & BRANIGAN, P.C., 2200 CLARENDON BLVD., SUITE 1400, ARLINGTON, VA, 22201, US

(73) Assignee: ARKEMA FRANCE, Colombes (FR)

(21) Appl. No.: 12/679,611

(22) PCT Filed: Sep. 19, 2008
(86) PCT No.: PCT/FR08/51690

§ 371 Date: Mar. 23, 2010

(30) Foreign Application Priority Data
Sep. 24, 2007 (FR) 07 06664

(51) Int. Cl. B29C 67/06

(52) U.S. Cl. 264/117; 977/773

(57) ABSTRACT

The invention relates to a method for producing a composite material, that comprises: a—preparing a carbon nanotube-based master mixture according to a method that comprises: mixing the carbon nanotubes in the form of a powder and at least one thermoplastic and/or elastomer polymer matrix in the form of a powder, the amount of carbon nanotubes representing from 2 to 30 wt % relative to the total weight of the powdery mixture; and implementing said mixture into an agglomerated solid physical form; and B—placing said master mixture into a thermoplastic and/or elastomer polymer mixture. The invention also relates to the use of the above master mixture for implementing said method.

The present invention relates to a method for the manufacture of a composite comprising: the preparation of a masterbatch based on carbon nanotubes, under given conditions, and the introduction of said masterbatch into a thermoplastic and/or elastomeric polymer composition.

Carbon nanotubes (or CNTs) are known and possess particular crystalline structures, of tubular shape, which are hollow and closed, made up of atoms arranged regularly in the form of pentagons, hexagons and/or heptagons, obtained from carbon. CNTs generally consist of one or more rolled-up graphite sheets. A distinction must thus be made between single-walled nanotubes (SWNTs) and multi-walled nanotubes (MWNTs).

CNTs are commercially available or can be prepared by known methods. There are several methods for synthesizing CNTs, especially by electrical discharge, by laser ablation and by CVD (chemical vapor deposition) enabling large quantities of carbon nanotubes to be manufactured and therefore obtained for a manufacturing cost compatible with their bulk use. This method specifically consists in injecting a carbon source at relatively high temperature onto a catalyst, which may itself consist of a metal such as iron, cobalt, nickel or molybdenum, which is supported on an inorganic solid such as alumina, silica or magnesia. The carbon sources may be methane, ethane, ethylene, acetylene, ethanol, methanol or even a mixture of carbon monoxide and hydrogen (HIPCO process).

Thus, application WO 86/03455 A1 by Hyperion Catalysis International Inc. describes, in particular, the synthesis of CNTs. More particularly, the method comprises bringing a particle based on metal such as, in particular, iron, cobalt or nickel, into contact with a carbon-based gaseous compound, at a temperature between 850° C. and 1200° C., the proportion, on a dry weight basis, of the carbon-based compound relative to the metal-based particle being at least around 100:1.

From a mechanical standpoint, the CNTs exhibit excellent stiffness (measured by Young's modulus), comparable to that of steel, while at the same time being extremely light. Furthermore, they exhibit excellent electrical and thermal conductivity properties making it possible to envisage using them as additives in order to confer these properties on various materials, especially macromolecular materials, such as thermoplastics and elastomers. Thermoplastics constitute a significant class of synthetic materials increasingly used in diverse applications. Due to their lightness, their high mechanical strength and their resistance to environmental effects, thermoplastics constitute an ideal material especially for the construction industry (installation of pipework, lines, etc.), containers, packaging (bottles and flasks), electrical insulation, electrical goods, clothing, window frames and the motor vehicle industry. As regards elastomers, their high elasticity makes them indispensible in the manufacture of mechanical parts, for instance in the transport of electrical energy or in the field of hygiene.

It has thus been suggested in document US 2002/0185770 to prepare sheets or rods based on CNTs and on a pulverulent thermoplastic or thermosetting polymer. Nanocomposites have also been proposed by McNally at al., in Polymer, Elsevier Science Publishers B.V., Vol. 46, No. 19, pp. 8822-8232 (2005) via extrusion of medium-density polyethylene powder with 0.1-10% of CNTs. The extruded product is then molded by compression in order to form sheets.

However, CNTs prove to be difficult to handle and disperse, because of their small size, their pulverulence and possibly, when they are obtained by the CVD technique, their entangled structure, even more so when it is desired to increase their mass productivity for the purposes of improving production and of reducing the residual ash content. The existence of strong van der Waals interactions between the nanotubes also adversely affects their dispersibility and the stability of the suspensions obtained.

The poor dispersibility of the CNTs significantly affects the performances of the composites that they form with the polymer matrices into which they are introduced. In particular, the appearance of nanocracks, that are formed in the nanotube aggregates, is observed which results in an embrittlement of the composite. Furthermore, as far as the CNTs are poorly dispersed, it is necessary to increase their content in order to attain a given electrical and/or thermal conductivity, which has the effect of increasing the viscosity of the final composite which may induce self-heating which may lead to a degradation of the polymer and/or to a reduction of the productivity (decrease of the line speeds in order to limit the pressure generated by the viscosity of the product).

The poor dispersibility of the carbon nanotubes is especially observed in the case of thermoplastic and/or elastomeric polymer matrices, in particular when the polymer is used in the form of granules, as described, in particular, in document US 2004/026581.

In order to overcome these drawbacks, various solutions have already been proposed in the prior art. Among these, it has been suggested to prepare mixtures of CNTs in a solvent with dispersants such as surfactants including sodium dodecylsulfate (EP-1 495 171; Vigolo B. et al., Science, 290 (2000), 1331; Wang J. et al., J. of Chem. Society, 125, (2003), 2408; Moore V. C. et al., Nanoletters, 3, (2003), 2408). The latter do not however make it possible to disperse large quantities of CNTs, satisfactory dispersions being able to be obtained only for CNT concentrations of less than 2 or 3 g/l. Moreover, the surfactants are capable of entirely desorbing from the surface of the CNTs during the dialysis step generally carried out in order to eliminate the excess of surfactant in the solution, which has the effect of destabilizing the suspension obtained.

Another solution, described in application WO 2007/063253, consisted in producing pulverulent compositions based on carbon nanotubes and on a compound A, the compound A possibly being a monomer, a molten polymer, a solution of monomer(s) and/or of polymer(s), a surfactant, etc., the physical form of which may be liquid, solid or gaseous. However, the final solid mixture thus obtained is in the form of a powder which is not always very easy to handle and to store, and its compounding still has to be carried out in order to obtain the final material.

Similarly, document JP 2003/012939 also discloses a pulverulent masterbatch based on CNTs and on polyamide.

Furthermore, the article by Qian et al. in Fangzhi Xuebao, Vol. 26, No. 3, pp. 21-23 (2005) discloses a masterbatch prepared by mixing CNTs, the content of which is not indicated, and of polyethylene powder, and extrusion of the mixture obtained as chips.

There is therefore still a need to provide a simple and inexpensive process for preparing composites based on homogeneous dispersions of carbon nanotubes in thermoplastic and/or elastomeric polymer materials, that have good mechanical (for example, high-temperature creep resistance for elastomers, low-temperature impact strength for thermoplastics), thermal and electrical properties. It is in particular desirable to be able to obtain these composites from a masterbatch that is in a physical form that can be handled more easily than powders.

The applicant has discovered that this need can be satisfied by using a masterbatch prepared from carbon nanotubes in powder form and from a thermoplastic and/or elastomeric polymer in powder form, the masterbatch itself being in an agglomerated solid physical form such as a granule.

One subject of the present invention is thus a method for manufacturing a composite comprising:

A—the preparation of a masterbatch based on carbon nanotubes (hereinbelow, CNTs) according to a method comprising:
the mixing of carbon nanotubes in powder form and of at least one thermoplastic and/or elastomeric polymer matrix in powder form, the amount of carbon nanotubes representing from 2% to 30% by weight, relative to the weight of the total pulverulent mixture; and
the processing of said mixture in an agglomerated solid physical form; and
   B—the introduction of said masterbatch into a thermoplastic and/or elastomeric polymer composition.

Another subject of the present invention is the use of the masterbatch defined previously for implementing the aforementioned method, in particular for conferring at least an electrical, mechanical and/or thermal property on the polymer matrix.

The expression “masterbatches” is understood to mean concentrates of active material that are the CNTs, which are intended to be subsequently incorporated into a polymer (compatible or non-compatible with the polymer already contained in these masterbatches).

The use of a masterbatch in an agglomerated solid physical form has a certain number of advantages such as, in particular, the absence of fines, good flowability in the hoppers, precise and loss-free metering, easy handling, good dispersion, lower volatility and lower sensitivity to moisture compared to powders, reduced risks linked to handling, a mass and volume lower than liquids, the absence of precipitation and of settling of the solutions or of the suspensions, and also a substantial reduction of the risks due to transport.

The carbon nanotubes that can be used according to the invention may be of the single-walled, double-walled or multi-walled type. Double-walled nanotubes may especially be prepared as described by Flahaut at al. in Chem. Com. (2003), 1442. Multi-walled nanotubes may, for their part, be prepared as described in document WO 03/02456.

The masterbatch used according to the invention comprises from 2% to 30% by weight, preferably from 5% to 25% by weight and more preferably from 10% to 20% by weight of CNTs, relative to the weight of the total pulverulent mixture.

The composite obtained preferably comprises from 0.5% to 20% by weight, preferably from 0.5% to 10% by weight and more preferably from 0.5% to 5% by weight of CNTs, relative to the weight of the total pulverulent mixture.

The nanotubes used according to the invention customarily have an average diameter ranging from 0.1 to 200 nm, preferably from 0.1 to 100 nm, more preferably from 0.4 to 50 nm and, better still, from 1 to 30 nm and advantageously a length of more than 0.1 μm and advantageously from 0.1 to 20 μm, for example around 6 μm. Their length/diameter ratio is advantageously greater than 10 and usually greater than 100. These nanotubes therefore comprise, in particular, what are known as VGCF (vapor-grown carbon-fiber) nanotubes. Their specific surface area is, for example, between 100 and 300 m²/g and their bulk density may in particular be between 0.05 and 0.5 g/cm³ and more preferably between 0.1 and 0.2 g/cm³. The multi-walled carbon nanotubes may, for example, comprise 5 to 15 sheets and more preferably 7 to 10 sheets.

An example of raw carbon nanotubes is in particular commercially available from the company Arkema under the brand name Graphistrength® C100.

The nanotubes may be purified and/or treated (in particular oxidized) and/or milled before their use in the method according to the invention. They may also be functionalized by chemical methods in solution, such as amination or reaction with coupling agents.

The milling of the nanotubes may in particular be carried out cold or hot using known processing techniques in equipment such as ball mills, hammer mills, grinding mills, knife or blade mills, gas jets or any other milling system that can reduce the size of the entangled network of nanotubes. It is preferable for this milling step to be carried out using a gas jet milling technique, in particular in an air jet mill.

The nanotubes may be purified by washing with a solution of sulfuric acid or another acid, so as to strip them of any residual metallic or mineral impurities resulting from their method of preparation. The weight ratio of nanotubes to sulfuric acid may especially be between 1/2 and 1/3. The purifying operation may also be carried out at a temperature ranging from 90 to 120° C., for example for a time of 5 to 10 hours. This operation may advantageously be followed by steps in which the purified nanotubes are rinsed with water and dried.

Advantageously, the oxidation of the nanotubes is carried out by bringing them into contact with a sodium hypochlorite solution containing 0.5 to 15% NaOCl by weight and preferably 1 to 10% NaOCl by weight, for example in a nanotube/sodium hypochlorite weight ratio ranging from 1/0.1 to 1/1. Advantageously, the oxidation is carried out at a temperature below 60° C. and preferably at room temperature, for a time ranging from a few minutes to 24 hours. This oxidation operation may advantageously be followed by steps in which the oxidized nanotubes are filtered and/or centrifuged, washed and dried.

In the method according to the invention, the nanotubes (raw or milled and/or purified and/or oxidized and/or functionalized by a non-plasticizing molecule) are brought into contact with at least one thermoplastic and/or elastomeric polymer matrix.

The expression “thermoplastic polymer matrix” is understood, within the meaning of the present invention, to mean a polymer or mixture of polymers which melts when it is heated and which may be formed in the melt state.

Today there are many types of thermoplastics that offer a vast range of advantageous properties. It is possible to make them as flexible as rubber, as rigid as metal and concrete, or to manufacture them as transparent as glass, for use in numerous pipework products and other components. They do not oxidize and have a high corrosion resistance.

Among the main thermoplastic polymers that can be used according to the method of the invention, mention may especially be made of polyamide (PA) such as polyamide 6 (PA-6), polyamide 11 (PA-11), polyamide 12 (PA-12), polyamide 6,6 (PA-6,6), polyamide 4,6 (PA-4,6), polyamide 6,10 (PA-6,10) and polyamide 6,12 (PA-6,12), some of these polymers being sold, in particular, by Arkema under the name Rilsan® and the preferred ones being those of fluid grade such as Rilsan® AMNO TLD. Mention may also be made of polyvinylidene fluoride (PVDF) such as the product sold under the trade mark Kynar® by Arkema, acrylonitrile-butadiene-styrene (ABS), acrylonitrile/methyl methacrylate (AMMA), cellulose acetate (CA), ethylene/propylene copolymer (E/P), ethylene/tetrafluoroethylene copolymer (ETFE), ethylene/vinyl acetate (EVAC), ethylene/vinyl alcohol (EVOH), methyl methacrylate/acrylonitrile-butadiene-styrene (MARS), methyl cellulose (MC), methyl methacrylate/butadiene-styrene (MBS), polyamide-imide (PAI), polybutylene terephthalate (PBT), polycarbonate (PC), polyethylene (PE), high-density polyethylene (HDPE), polyester carbonate (PEC), polyether ether ketone (PEEK), polyether ester (PEEST), polyether ketone (PEK), polyethylene naphthalate (PEN), polyether sulfone (PESO), polyethylene terephthalate (PET), polyethylene (poly)terephthalate (PETP), perfluoroalkoxyl alkane polymer (PFA), polyimide (PI), polyketone (PK), polyacrylates and/or polymethacrylates such as polymethyl methacrylate (PMMA), polymethylpentene (PMP), polyoxymethylene or polyacetal (POM), polypropylene (PP), polyphenylene ether (PPE), polypropylene oxide (PPDX), polyphenylene sulfide (PPS), polystyrene (PS), polysulfone (PSU), polytetrafluoroethylene (PTFE), polyvinyl acetate (PVAC), polyvinyl chloride (PVC), polyvinyl fluoride (PVF), poly(styrene-butadiene) (S/B), styrene/maleic anhydride (SMAH), vinyl ester resin (VE), polyphosphazenes, polyetherimide (PEI), polychlorotrifluoroethylene (PCTFE), polyarylsulfone, etc.

The expression “elastomeric polymer matrix or elastomer” is understood, within the meaning of the present invention, to mean an elastic polymer, i.e. a polymer which withstands very large deformations, much greater than 100% and that are (almost) completely reversible. An elastomer is constituted of long molecular chains assembled, at rest, as “balls of thread”. These chains are joined to one another by crosslinking points, entanglements or else polar bonds with mineral fillers, and form a network.

It is clearly understood that some of the polymers that can be used according to the method of the invention may be simultaneously thermoplastic and elastomeric.

Among the elastomers, mention may especially be made of fluoroelastomers such as those sold under the trade marks Kalrez® and Viton® by DuPont Performance Elastomers, natural or synthetic latex, chloroprene-based rubber such as that sold under the trade mark Neoprene® by DuPont Chemicals, polyacrylics, polybutadiene, polyether block amides, polyisobutylene, polyisoprene, polyurethane, silicones, natural rubber (styrene-butadiene rubber or SBR), the elastomers sold under the trade marks Vistamaxx®, Vistaflex® Thermoplastic Elastomers, Dytron® Thermoplastic Elastomers and Santoprene® Thermoplastic Vulcanizates by ExxonMobile Chemical, etc.

The term “polymer” according to the invention also covers oligomers, and also alloys of thermoplastic polymers with themselves, of elastomers with themselves or of one with the other.

It is preferred that the masterbatch, used according to the invention comprises from 95% to 70% by weight, and preferably from 90% to 80% by weight of polymer matrix relative to the weight of the total pulverulent mixture.

The composite obtained according to the invention thus advantageously comprises from 99.5% to 80% by weight, and preferably from 99.5% to 95% by weight of polymer matrix, relative to the weight of the total pulverulent mixture.

The average particle size of the polymer matrix powder is, preferably, between 0.1 μm and 1000 μm, preferably between 10 μm and 800 μm, and more preferably still between 50 μm and 300 μm. Advantageously, the average particle size of the polymer matrix powder is between 100 μm and 150 μm.

In order to obtain this polymer powder, it is possible, for example, to mill commercially available polymer granules to the desired size.

The first step of the method according to the invention consists in mixing the CNT and polymer matrix powders, which will then be processed in the second step.

The CNT and polymer powders may be mixed in a mixer which is either integrated into the processing equipment, or positioned upstream of the latter.

This mixing of powders may be carried out in conventional synthesis reactors, blade mixers, fluidized-bed reactors or in mixing equipment of the Brabender, Z-blade mixer or extruder type. According to one variant of the invention, it is thus possible to use a paddle or blade mixer.

The pulverulent mixture of CNTs and of at least one polymer matrix may, in addition, comprise one or more other pulverulent fillers. Mention may especially be made of carbon blacks, activated carbons, silicas, metals, ceramic materials, glass fibers, pigments, clays, calcium carbonate, nanotubes of boron and/or nitrogen and/or transition metals, metals or ceramic materials.

This first step of dry mixing of powders or dry-blending step is preferably followed by a heat treatment step where the passage of the polymer in liquid or gaseous form takes place in order to ensure intimate and homogeneous mixing of the polymer with the CNTs. This heat treatment consists of an increase in temperature of the powder so that its physicochemical properties are modified. This heat treatment is advantageously carried out in an extruder.

The second step of the method according to the invention consists of the processing of the mixture in order to obtain agglomerated solid physical forms. This step may be carried out by any method known to a person skilled in the art.

In particular, mention may be made of fluidized-bed agglomeration, which is a conventional method for obtaining granules from powder. The fluidized powder is moistened until liquid bridges form between the particles. Water, solutions, suspensions or molten materials may be sprayed in order to achieve the desired product quality. By virtue of this technology, the content of fines is considerably reduced, the fluidity and the dispersibility in water are improved, the granules obtained are very aerated and dissolve very readily. The agglomeration process, via its action, solves the problems of stability of the powdery mixtures.

Another processing method is spray granulation, which is a simultaneous method. The granules form during the evaporation of the fluid. These granules are harder and denser than via agglomeration.

It is possible, as a variant, to use a wet granulation process which consists in introducing the powder into a vertical granulator and in moistening it thoroughly by spraying. The mixture is then vigorously mixed by an impeller and a chopper. In this process where the powder is compressed, the result is denser granules than via fluidized-bed agglomeration.

Another method that can be used is the injection compression molding method that consists in injecting a cake of material in the melt state that is then compressed in order to fill a mold. A compressed solid product is then obtained.

Yet another preferred method that can be used according to the invention is the compounding method which is a continuous method comprising kneading, cooling and granulation steps. The mixture of CNTs and of polymer arrives at the head of an extruder or in a first segment of the latter, in powder form, and is poured into the hopper in order to feed the screw of the extruder, which is preferably a twin-screw extruder or a co-kneader. In the extruder, the mixture is heated and softened, by virtue of a worm screw which is in a barrel (tube) that is heated in order to make the material malleable. The screw drives the material towards the outlet. The outlet head of the extruder gives its shape to the exiting material. The tube or rod exits continuously, it is cooled in order to then be chopped into granules.

In one advantageous form of execution of the invention, the pulverulent thermoplastic and/or elastomeric polymer, into which the masterbatch must be introduced, is fed into a second segment of the extruder or of the mixer used for the manufacture of this masterbatch. In this form of execution, the manufacture of the composite may take place continuously in the same equipment.

The expression “agglomerated solid physical form” is understood, within the context of the present invention, to mean the final mixture after it has been processed according to the invention, in hard, for example substantially cylindrical, spherical, ovoid, rectangular or prismatic, form. Mention may be made, for example, of granules, pellets and pebbles as agglomerated solid physical forms. The diameter of this agglomerated solid physical form may be between 1 mm and 10 mm, but more preferably between 2 mm and 4 mm.

The masterbatch obtained as described previously is intended to be introduced into a thermoplastic and/or elastomeric polymer composition in order to form a composite. It is generally preferred to use the same family of polymers as that of the thermoplastic and/or elastomeric polymer included in the masterbatch. Examples of polymers that can be used are therefore those mentioned previously. In certain cases, it may, on the other hand, be advantageous to use a polymer that is not compatible with the matrix in order to obtain what is known as a “double percolation” effect.

According to one particularly preferred form of execution of the invention, the polymer is chosen from polyamides, polyvinylidene fluoride, polycarbonate, polyether ether ketone, polyphenylene sulfide, polyolefins, mixtures thereof and copolymers thereof.

The polymer composition, into which the masterbatch is introduced, may also contain various adjuvants and additives such as lubricants, plasticizers, pigments, stabilizers, fillers or reinforcements, antistatic agents, antifogging agents, fungicides, fire retardants and solvents.

As indicated previously, the method according to the invention makes it possible to improve the dispersion of the nanotubes in the polymer matrix and/or the mechanical properties (especially tensile strength and/or impact strength) and/or the electrical conductivity and/or the thermal conductivity of the polymer matrix.

Another advantage of said method is that it makes it possible to render composites comprising CNTs that have lower contents of CNTs compared to the prior art, conductive.

It is thus possible to confer on said composites containing less than 5% by weight of carbon nanotubes an electrical conductivity of less than 1 Mohm for dissipative applications and 10¹⁰ ohm for antistatic applications.

The invention will now be illustrated by the following non-limiting examples with the aid of the appended figures in which:

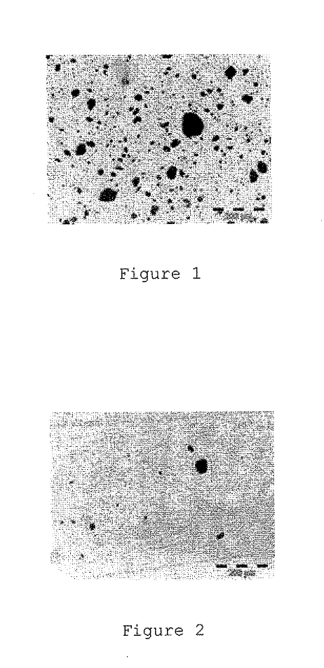

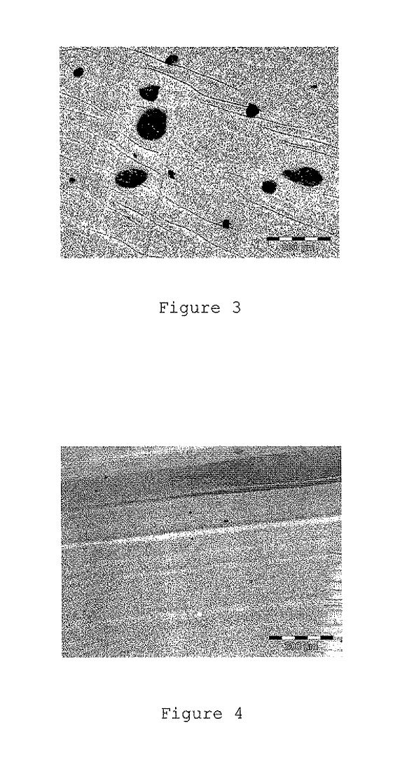

FIGS. 1 and 3 illustrate a dispersion of comparative composites;

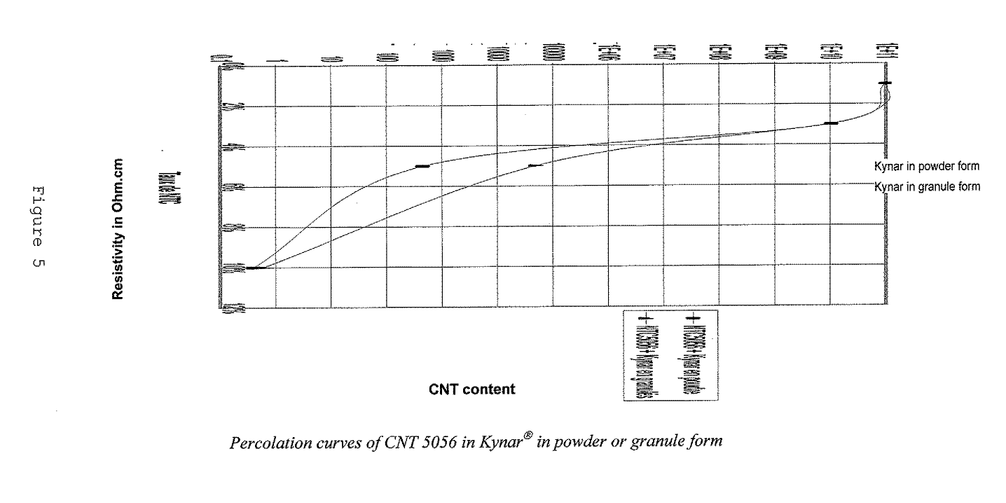

FIGS. 2 and 4 illustrate a dispersion of composites prepared according to the invention; and

FIG. 5 represents two percolation curves of a comparative composite and of a composite prepared according to the invention.

### EXAMPLES

### Example 1

### Preparation of a CNT/Polyamide 12 (PA-12) composite

Using a BUSS 15D co-kneader, 5% of powdered CNTs (Graphistrength® C100 from Arkema) were mixed into 95% of powdered polyamide-12 (Rilsan® AMNO TLD from Arkema—fluid polyamide grade) at a throughput of 10 kg/h with a barrel temperature profile of 250° C./250° C./250° C./220° C., a screw profile at 210° C., and a screw speed of 250 rpm, in order to obtain a composite containing 5% by weight of CNTs and 95% by weight of PA-12.

By way of comparison, the same experiment was carried out, no longer using a polymer powder but polymer granules.

Images were then taken using a transmitted-light optical microscope from sections having a thickness of 2 μm cut parallel to the extrusion direction, at a rate of 6 images per section, at the nominal magnification of 200×. The percentage of the surface of these composites occupied by CNT aggregates was then evaluated. The average of the values obtained for each of the 6 images was calculated.

The results obtained are collated in Table 1 below.

TABLE 1

| | | Composite obtained |
|---|---|---|
| | Comparative | according to the |
| | composite | invention |
| | (FIG. 1) | (FIG. 2) |
| Average % of | 10% | 1.7% |
| surface occupied by | | |
| CNT agglomerates | | |

From Table 1 and FIGS. 1 and 2, it is therefore observed that the composites obtained according to the invention have a better dispersion of the CNTs in the polyamide matrix, which should result in better mechanical properties such as their impact strength or crack resistance in particular.

### Example 2

### Preparation of a Masterbatch Based on Polyamide 12 (PA-12)

Using a BUSS 15D co-kneader, 20% of powdered CNTs (Graphistrength® C100 from Arkema) were mixed into 80% of powdered polyamide-12 (Rilsan® AMNO TLD from Arkema—fluid polyamide grade) at a throughput of 10 kg/h with a barrel temperature profile of 250° C./250° C./250° C./210° C., a screw profile at 210° C., and a screw speed of 280 rpm, in order to obtain a composite containing 20% by weight of CNTs and 80% by weight of PA-12.

By way of comparison, the same experiment was carried out, no longer using a polymer powder but polymer granules.

Images were then taken using a transmitted-light optical microscope from sections having a thickness of 2 μm cut parallel to the extrusion direction, at a rate of 6 images per section, at the nominal magnification of 200×. The percentage of the surface of these composites occupied by CNT aggregates was then evaluated. The average of the values obtained for each of the 6 images was calculated.

The results obtained are collated in Table 2 below.

TABLE 2

| | | Composite obtained |
|---|---|---|
| | Comparative | according to the |
| | composite | invention |
| | (FIG. 3) | (FIG. 4) |
| Average % of | 5.5% | 0.2% |
| surface occupied by | | |
| CNT agglomerates | | |

From Table 2 and FIGS. 3 and 4, it is therefore observed that the composites obtained according to the invention have a better dispersion of the CNTs in the polyamide matrix, which should result in better mechanical properties such as their impact strength or crack resistance in particular.

### Example 3

### Preparation of a CNT/Polyvinylidene Fluoride (PVDF) Composite

5% of powdered CNT (Graphistrength® C100 from Arkema) was mixed into 95% of powdered PVDF (Kynar® 721 from Arkema), then this mixture was processed using a DSM micro-compounder.

The kneading was carried out by two co-rotating screws (screw speed: 100 rpm) at a temperature of 230° C. for a duration of 10 min. At the end of the kneading, the injection molding was carried out at 230° C. in a mold preheated to 90° C. in order to obtain a pellet.

### Example 4

### Measurement of the Resistivity of Composites Obtained According to the Invention

The measurement of the resistivity was carried out using the four-wire measurement system for its precision and the stability of the measurement.

CNT/PVDF composites were prepared according to the procedure from Example 3 so as to obtain composites based on Kynar® 721 containing from 1% to 10% by weight of CNTs (Graphistrength® C100 from Arkema).

A comparative test was carried out between these composites (Kynar® 721), the initial PVDF of which is in powder form and composites prepared in an identical manner based on Kynar® 720, the initial PVDF of which is in granule form. There is no difference in composition between Kynar® 721 and Kynar® 720 apart from the initial physical form in which they are present. Indeed, Kynar® 721 is in powder form and the particle size is generally less than 30 μm whilst Kynar® 720 is in the form of granules, of which the diameter is 0.4-0.5 cm and the thickness is 0.2-0.4 cm.

The resulting percolation curves are illustrated in the appended FIG. 5.

### Results:

As illustrated in FIG. 5, the resistivity of the composites decreases when the content of CNTs that they contain increases. Moreover, that of the composites obtained according to the invention always remains below, starting from a CNT content of about 3.4% to a CNT content of about 10%, that of the composites obtained from granulated polymer, which is expressed by their better electrical conductivity and the better dispersion of the CNTs in these composites according to the invention.

More particularly, the use of PVDF in powder form (Kynar® 721) and not in granule form (Kynar® 720) leads to a substantial improvement of the conductivity on injection-molded pellets having a CNT content of 5%. Indeed, the resistivity measured on the composite obtained from powder is 454 Ω·cm whereas that measured for the composite based on granules is at least 100 times higher.

### Example 5

### Comparison of the Methods for Processing the Composites

Table 3 below compares the two DSM microextrusion and Rheocord internal mixer mixing systems and also the two powder/granule processing techniques at CNT contents of 2% and 5%.

TABLE 3

| | Composition | | | |
|---|---|---|---|---|
| | A | B | C | D |
| Kynar ® | 720 | 721 | 720 | 721 |
| Polymer form | Granule | Powder | Granule | Powder |
| CNT content | 2% | 2% | 5% | 5% |
| Mixer tool | Rheocord | Rheocord | DSM | DSM |
| Processing of | Compression | Compression | Injection | Injection |
| the pellets | | | | |
| Resistivity | 20 | 4.6 | 50 000 or | 50-200 |
| (Ω · cm) | | | more | |

### Preparation of Compositions A-D:

The composition A is obtained by introducing into a mixer of the Rheocord Haake 90 type, 98% of PVDF (Kynar® 720) in the form of granules that are melted, then 2% of CNT in the form of powder (Graphistrength® C100 from Arkema).

Composition B is obtained by manually dry mixing 2% of CNT in the form of powder (Graphistrength® C100 from Arkema) and 98% of PVDF (Kynar® 720) in the form of powder, then by processing this mixture in a mixer of the Rheocord Haake 90 type.

The mixing conditions for the Rheocord are the following:
mixing temperature: 230° C.
rotational speed of the Brabender type rotors: 100 rpm
kneading time: 10 min.

The compositions A and B are formed into pellets by compression molding according to a method comprising the steps consisting in:
chopping up the CNT and Kynar® mixture and placing, it in a mold,
letting it flow for 10 min in a press at a temperature of 230° C.,
press-molding for 5 min at high temperature, at a pressure of 250 bar,
maintaining the pressure and stopping the heating of the plates for a cooling time of 20 min, and
demolding.

Pellets having a diameter of around 2 cm and a thickness around 0.1 cm are obtained. The measurement of the resistivity can be carried out.

The composition C is obtained by manually dry pre-mixing 95% of PVDF (Kynar® 720) in the form of granules and 5% of CNT in the form of powder (Graphistrength® C100 from Arkema), then by introducing this premix into a Micro 15 Compounder® model microextruder from DSM.

The kneading was carried out by two co-rotating screws (screw speed: 100 rpm) at a temperature of 230° C. for a duration of 10 min. At the end of the kneading, the injection molding was carried out at 230° C. in a mold preheated to 90° C. in order to obtain a pellet.

The composition D is obtained by manually dry pre-mixing 5% of CNT in the form of powder (Graphistrength® C100 from Arkema) and 95% of PVDF (Kynar® 720) in the form of powder, then by introducing this premix into a Micro 15 Compounder® model microextruder from DSM. The kneading was carried out by two co-rotating screws (screw speed: 100 rpm) at a temperature of 230° C. for a duration of 10 min. At the end of the kneading, the injection molding was carried out at 230° C. in a mold preheated to 90° C. in order to obtain a pellet.

The compositions C and D are thus formed into pellets by injection molding.

### Results:

The pellets manufactured by compression molding (CNT content of 2%) from a Kynar® powder have a lower resistivity value than those obtained from Kynar® granules.

This phenomenon is more pronounced for the pellets manufactured by injection molding having a CNT content of 5%, which is probably due to the fact that they are very close to the percolation threshold.

1. A method for manufacturing a composite comprising:
A—the preparation of a masterbatch based on carbon nanotubes according to a method comprising:
the mixing of carbon nanotubes in powder form and of at least one thermoplastic and/or elastomeric polymer matrix in powder form, the amount of carbon nanotubes representing from 2% to 30% by weight, relative to the weight of the total pulverulent mixture; and
the processing of said mixture in an agglomerated solid physical form; and
B—the introduction of said masterbatch into a thermoplastic and/or elastomeric polymer composition.

2. The method as claimed in claim 1, wherein the method for manufacturing the masterbatch, the amount of carbon nanotubes is between 5% and 25% by weight relative to the weight of the total pulverulent mixture.

3. The method as claimed in claim 1, wherein the thermoplastic polymer matrix and/or the thermoplastic and/or elastomeric polymer are polyamide, polyvinylidene fluoride, acrylonitrile-butadiene-styrene, acrylonitrile/methyl methacrylate, cellulose acetate, ethylene/propylene copolymer, ethylene/tetrafluoroethylene copolymer, ethylene/vinyl acetate, ethylene/vinyl alcohol, methyl methacrylate-acrylonitrile-butadiene-styrene, methyl cellulose, methyl methacrylate-butadiene-styrene, polyamide-imide, polybutylene terephthalate, polycarbonate, polyethylene, high density polyethylene, polyester carbonate, polyether ether ketone, polyether ester, polyether ketone, polyethylene naphthalate, polyethersulfone, polyethylene terephthalate, polyethylene (poly)terephthalate, perfluoroalkoxy alkane polymer, polyimide, polyketone, polyacrylates and/or polymethacrylates such as polymethyl methacrylate, polymethylpentene, polyoxymethylene or polyacetal, polypropylene, polyphenylene ether, polypropylene oxide, polyphenylene sulfide, polystyrene, polysulfone, polytetrafluoroethylene, polyvinyl acetate, polyvinyl chloride, polyvinyl fluoride, poly(styrene-butadiene), styrene/maleic anhydride, vinyl ester resin, polyphosphazenes, polyetherimide, polychlorotrifluoroethylene, polyarylsulfone, or mixtures thereof.

4. The method as claimed in claim 1, wherein the elastomeric polymer matrix and/or the thermoplastic and/or elastomeric polymer are fluoroelastomers, natural or synthetic latex, chloroprene-based rubber, polyacrylics, polybutadiene, polyether block amides, polyisobutylene, polyisoprene, polyurethane, silicones, natural rubber, or mixtures thereof.

5. The method as claimed in claim 1, wherein the nanotubes have a diameter ranging from 0.1 to 100 nm.

6. The method as claimed in claim 1, wherein the polymer matrix in powder form is particles having an average size between 0.1 μm and 1000 μm.

7. The method as claimed claim 1, wherein the nanotubes have a length of 0.1 to 20 μm.

8. The method as claimed in claim 1, wherein the agglomerated solid physical form is a granule, a pellet or a pebble.

9. The method as claimed in claim 1, wherein the agglomerated solid physical form has a diameter between 1 mm and 10 mm.

10. The method as claimed in claim 1, wherein the processing of the mixture is carried out by compounding.

11. (canceled)

12. A method for conferring at least an electrical, mechanical and/or thermal property on a thermoplastic and/or elastomeric polymer composition comprising introducing into said composition a masterbatch containing carbon nanotubes, wherein said masterbatch has been prepared according to a method comprising:
mixing of carbon nanotubes in powder form and of at least one thermoplastic and/or elastomeric polymer matrix in powder form, the amount of carbon nanotubes representing from 2% to 30% by weight, relative to the weight of total pulverulent mixture; and
processing of said mixture in an agglomerated solid physical form.

13. The method as claimed in claim 1, wherein the method for manufacturing the masterbatch, the amount of carbon nanotubes is between 10% and 20% by weight relative to the weight of the total pulverulent mixture.

14. The method as claimed in claim 1, wherein the nanotubes have a diameter ranging from 1 to 30 nm.
